(19) United States
(12) Patent Application Publication
(10) Pub. No.: US 2007/0283311 A1
(43) Pub. Date: Dec. 6, 2007

(54) Method and system for dynamic reconfiguration of field programmable gate arrays

(76) Inventors: Theodore Karoubalis, Pireus (GR); Kelly Nasi, Patras (GR); Jiri Kadlec, Praha (CZ); Martin Danek, Praha (CZ); Rudolf Matousek, Konesin (CZ)

Correspondence Address: SAWYER LAW GROUP LLP, P O BOX 51418, PALO ALTO, CA, 94303, US

(21) Appl. No.: 11/442,771

(22) Filed: May 30, 2006

(51) Int. Cl. G06F 17/50

(52) U.S. Cl. 716/16

(57) ABSTRACT

A field programmable gate array (FPGA) and methods for executing operations using an FPGA are provided. The method includes providing a first dynamic macro and a second dynamic macro in the FPGA. The first dynamic macro and the second dynamic macro each represent logic within the FPGA that can be reconfigured. The method further includes executing a first operation associated with the user application using the first dynamic macro; reconfiguring the second macro to execute a second operation associated with the user application prior to completion of the first operation; and upon completion of the first operation, executing the second operation using the second dynamic macro.

### FIELD OF THE INVENTION

The present invention relates generally to digital circuits, and more particularly to dynamic reconfiguration of field programmable gate arrays (FPGAs).

### BACKGROUND OF THE INVENTION

Field programmable gate arrays (FPGAs) are a class of programmable logic devices. FPGAs generally feature a gate array architecture with a matrix of logic cells surrounded by a periphery of input/output (I/O) cells (or pins). Logic within the gate array architecture can be reconfigured (or re-programmed) after an FPGA has been manufactured, rather than having the programming fixed during manufacturing. Accordingly, with an FPGA, a design engineer is able to program electrical connections on-site for a specific application (for example, a device for a sound/video accelerator card).

Reconfiguration of an FPGA can be classified according to two basic criteria—the method of reconfiguration and the amount of reconfiguration logic in terms of device (FPGA) size. With respect to the method of reconfiguration, there are three general categories. None—the FPGA is either factory-programmed, or implements antifuse technology. Static reconfiguration—operation of the FPGA must be halted (or stopped) in order for the FPGA to be re-programmed. Dynamic reconfiguration—parts of an FPGA may be in operation while other parts of the FPGA are re-programmed. With respect to the amount of reconfiguration logic in terms of device size, there are two general categories. Full—the device requires a full configuration bitstream that describes all programmable logic blocks of the device. Partial—the device permits partial bitstreams that describe less than all programmable logic blocks (e.g., specific logic blocks) of the device.

Interest in the dynamic reconfiguration of FPGAs have increased in recent years due to new application features that FPGAs provide, such as increased functional density, increased reliability, and self-adaptability. A common problem associated with dynamic reconfiguration of an FPGA, however, is that a pre-determined time is required to re-program (or reconfigure) the FPGA. The pre-determined time required to re-program an FPGA can adversely affect processing time of, for example, a user program.

Accordingly, what is needed is a system and method for dynamically reconfiguring an FPGA without adversely affecting processing time of user programs. The present invention addresses such a need.

### BRIEF SUMMARY OF THE INVENTION

In general, in one aspect, this specification describes a method of performing one or more operations associated with a user program using a field programmable gate array (FPGA). The method includes providing a first dynamic macro and a second dynamic macro in the FPGA. The first dynamic macro and the second dynamic macro each represent logic within the FPGA that can be reconfigured. The method further includes executing a first operation associated with the user program using the first dynamic macro; reconfiguring the second macro to execute a second operation associated with the user program prior to completion of the first operation; and upon completion of the first operation, executing the second operation using the second dynamic macro.

Particular implementations can include one or more of the following features. The field programmable gate array (FPGA) can substantially realize zero-time reconfiguration between executing the first and second operations. The first operation or the second operation can comprise a numeric operation. Providing a first dynamic macro and a second dynamic macro can further comprise providing a supermacro. The supermacro can contain one or more dynamic macros for performing operations associated with the user program. The method can further include organizing configuration data to reconfigure the second dynamic macro into a master bitstream file. The master bitstream file can store one or more partial bitstreams according to the following organization: <FPGA address><install data><remove data>, in which each partial bitstream represents the configuration data. The master bitstream file can have an addressing mechanism that includes an index table at a beginning of the master bitstream file that points to the beginning and end of each partial bitstream contained within the master bitstream file. The master bitstream file can have an addressing mechanism that includes pointers at a beginning of each partial bitstream that point to a beginning of the partial bitstream. The master bitstream file can have an addressing mechanism that comprises using data blocks of fixed length so as to contain a largest partial bitstream. A first word of each data block can contain a length of an associated partial bitstream.

In general, in another aspect, this specification describes a field programmable gate array (FPGA). The field programmable gate array (FPGA) includes a static part that corresponds to logic within the field programmable gate array (FPGA) that is present in substantially all configurations of the field programmable gate array (FPGA), and dynamic part including a first dynamic macro and a second dynamic macro. The first dynamic macro and the second dynamic macro each represent logic within the field programmable gate array (FPGA) that can be reconfigured. The first dynamic macro is operable to execute a first operation associated with a user program. The second macro is operable to be reconfigured while the first dynamic macro is executing the first operation. Upon completion of the first operation, the second operation is operable to execute a second operation associated with the user program using the second dynamic macro.

In general, in another aspect, this specification describes a system for performing a specific task. The system includes a field programmable gate array (FPGA) operable to execute instructions associated with the task. The field programmable gate array (FPGA) includes a static part that corresponds to logic within the field programmable gate array (FPGA) that is present in substantially all configurations of the field programmable gate array (FPGA), and dynamic part including a first dynamic macro and a second dynamic macro. The first dynamic macro and the second dynamic macro each represent logic within the field programmable gate array (FPGA) that can be reconfigured. The first dynamic macro is operable to execute a first operation associated with the task. The second macro is operable to be reconfigured while the first dynamic macro is executing the first operation. Upon completion of the first operation, the second operation is operable to execute a second operation associated with the task using the second dynamic macro.

Implementations may provide one or more of the following advantages. An FPGA is provided that implements a supporting infrastructure in the static part that substantially operates in all configurations of the FPGA, and different user functions can be implemented on demand through dynamic reconfiguration. A software tool provides the means to place and route dynamically reconfigurable designs in the FPGA and also generate appropriate bitstream files. The described methods provide the following features: a way to define an organization and design description on the reconfigurable logic; a way to describe spatial and temporal FPGA contexts; a way to reduce placement complexity and guide the independent placements and routings of the independent contexts of the reconfigurable parts of the FPGA; a way to organize reconfiguration data into bitstreams in an efficient manner; and a way to implement reconfigurable accelerators attached to a microprocessor.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 is a block diagram of an FPGA in accordance with one implementation of the invention.

FIG. 2A illustrates the difference between the dynamic macro and a supermacro of FIG. 1 in accordance with one implementation of the invention.

FIG. 2B illustrates an example of an FPGA including a supermacro in accordance with one implementation of the invention.

FIG. 3 illustrates an architecture of an FPGA in accordance with one implementation of the invention.

FIG. 4 illustrates a system-on-chip (SoC) platform including an FPGA in accordance with one implementation of the invention.

FIG. 5 illustrates another view of the FPGA shown in FIG. 4 in accordance with one implementation of the invention.

FIG. 6 illustrates an application view of the FPGA shown in FIG. 4 in accordance with one implementation of the invention.

FIG. 7 illustrates an organization of a bitstream address in accordance with one implementation of the invention.

FIG. 8 illustrates three possible organization schemes of a master bitstream file in accordance with one implementation of the invention.

FIGS. 9A-9D illustrate net connectivity between inputs and outputs of a static part and a dynamic part of an FPGA.

FIG. 10 illustrates problems with dynamic macro implementations using current design synthesis tools in accordance with one implementation on the invention.

FIGS. 11A-11C illustrate a dynamic wrapper and a static wrapper in accordance with one implementation of the invention.

FIG. 12 illustrates one implementation of a simulated context reconfiguration on an FPGA without the context reconfiguration capability.

FIG. 13 illustrates a method of operation of an FPGA in accordance with one implementation of the invention.

FIG. 14 illustrates a system including the FPGA of FIG. 1 in accordance with one implementation of the invention.

Like reference symbols in the various drawings indicate like elements.

### DETAILED DESCRIPTION OF THE INVENTION

The present invention relates generally to digital circuits, and more particularly to dynamic reconfiguration of field programmable gate arrays (FPGAs). The following description is presented to enable one of ordinary skill in the art to make and use the invention and is provided in the context of a patent application and its requirements. Various modifications to the preferred implementations and the generic principles and features described herein will be readily apparent to those skilled in the art. Thus, the present invention is not intended to be limited to the implementations shown but is to be accorded the widest scope consistent with the principles and features described herein.

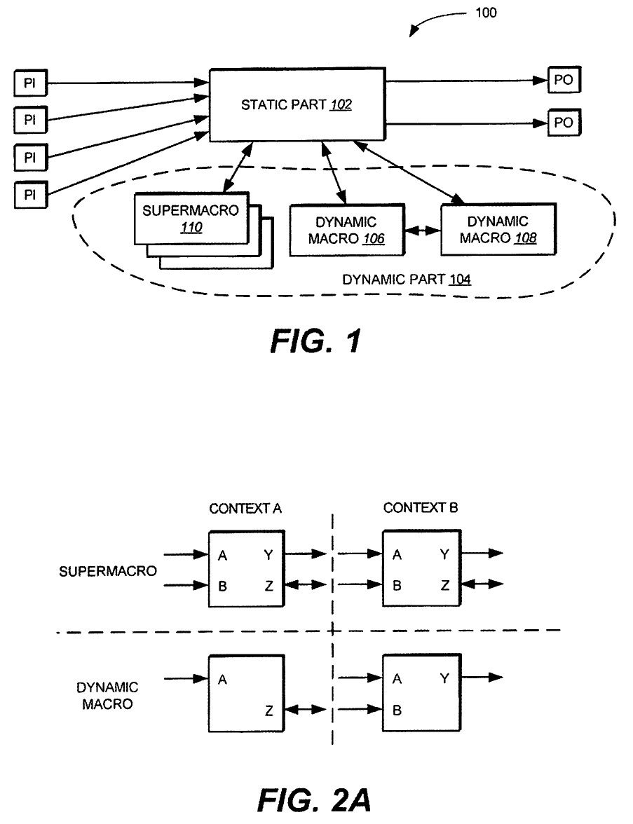

FIG. 1 illustrates a block diagram of an FPGA 100 according to one implementation of the invention. FPGA 100 includes a static part 102 and a dynamic part 104. In one implementation, static part 102 corresponds to logic within FPGA 100 that must always be present and running within FPGA 100, and dynamic part 104 corresponds to logic that can be loaded or unloaded from FPGA 100 as needed. In one implementation, only static part 102 is connected to one or more input pin (PI) and one or more output pins (PO) of FPGA 100.

Dynamic part 104 includes dynamic macros 106, 108 and a supermacro 110. Though dynamic part 104 is shown as including (2) dynamic macros and (1) supermacro, in general, dynamic part 104 contains at least two dynamic macros, or one dynamic macro and one supermacro, or one supermacro. A dynamic macro represents a portion of (user) logic that can be removed in certain configurations of FPGA 100. Accordingly, because dynamic macros (e.g., dynamic macros 106, 108) can be removed from certain configurations of FPGA 100, placement and routing constraints of logic within an FPGA can be alleviated since logic blocks can remain unplaced and nets unrouted without causing an error due to invalid placement or routing. In one implementation, dynamic macros 106, 108 are declared as VHDL/Verilog modules and are specified as VHDL/Verilog instances within static part 102.

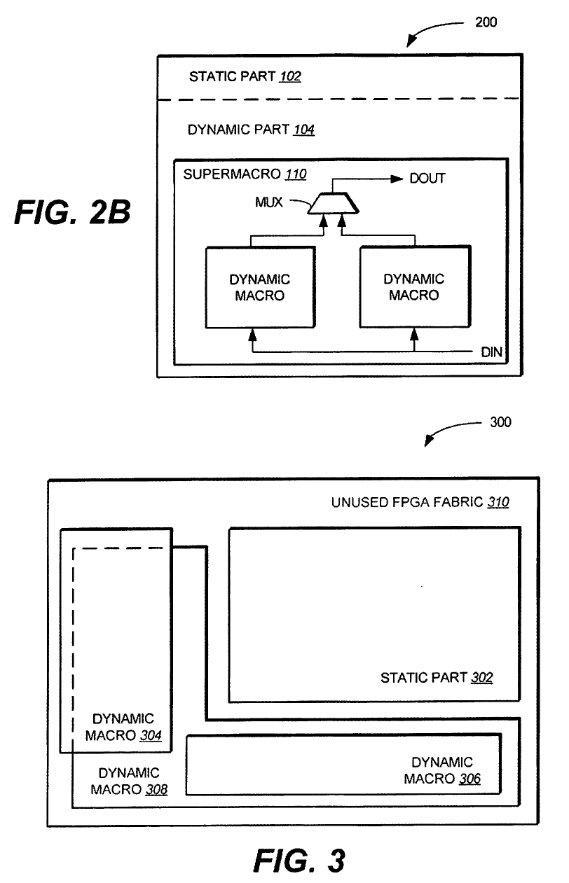

A supermacro is comprised of two or more dynamic macros that have the same input and output ports (interface), and which are exclusively in different design contexts (or FPGA configurations) at different times. Dynamic macros within a supermacro can use the same FPGA area. In one implementation, a supermacro (e.g., supermacro 110) can be viewed as several dynamic macros with inputs connected in parallel and outputs connected through a multiplexer, as illustrated by the example FPGA 200 shown in FIG. 2B. Referring back to FIG. 1, in one implementation, supermacro 110 is specified by one VHDL instance and represented by several EDIF files (i.e., VHDL entities) that have identical input and output ports. As shown in FIG. 1, supermacro 110 comprises (3) contexts. Referring to FIG. 2A, the difference between a supermacro and a dynamic macro is illustrated. Let us consider two different implementations with reconfigurable logic that have the same functionality: one with two dynamic macros and another with a supermacro with two contexts. Let us further assume that the function of each dynamic macro corresponds to each context of the supermacro.

With respect to the configured logic the design with the dynamic macros can be in four different configurations: no dynamic macro loaded, one dynamic macro loaded, the other dynamic macro loaded, both dynamic macros loaded.

With respect to the configured logic the design with the supermacro can be in three different configurations: no supermacro context loaded, the first supermacro context loaded, the second supermacro context loaded. A restriction posed by the use of supermacros is that all supermacro contexts (i.e., individual EDIF files that form the supermacro) must define and use the same input/output ports, even though some ports are not used in some contexts. On the other hand, dynamic macros do not require this, since it does not make sense for dynamic macros to define ports that are not used by the dynamic macro logic. A simple example that corresponds to the described example is shown in FIG. 2A.

As shown in FIG. 2A, the supermacro contains the same inputs (A, B) and the same outputs (Y, Z) between two different contexts (context A and context B). In contrast, a dynamic macro (in general) has different inputs and/or outputs between different contexts A and B—e.g., in context A the dynamic macro has (1) input A and (1) output Z, and in context B, the dynamic macro has (2) inputs (A, B) and (1) output Y.

Referring back to FIG. 1, a mutual dependency (or direct connection) between dynamic macro 106 and dynamic macro 108 is shown by the arrow connecting dynamic macro 106 and dynamic macro 108. Such a mutual dependency between two or more dynamic macros requires that the dependent dynamic macros always be present together (within a configuration), or that the dependency must be handled through logic within the static part (e.g., static part 102) of an FPGA.

In operation, by using two or more dynamic macros (e.g., dynamic macros 106, 108) or supermacros (e.g., supermacro 110), a zero configuration time can be substantially achieved. For example, in one implementation, a first dynamic macro (e.g., dynamic macro 106) is re-programmed while a second dynamic macro (e.g., dynamic macro 108) is performing a calculation associated with, for example, a user application. In one implementation, the user application is designed such that the time required to perform a user computation using any of the dynamic macros or supermacros in an FPGA is longer than the time needed to reconfigure (or re-program) any of the dynamic macros or supermacros. Thus, the FPGA does not have to wait for a given dynamic macro or supermacro to be reconfigured, and accordingly user applications are not adversely affected unlike in conventional FPGA designs. Accordingly, the two or more dynamic macros can be used to substantially (effectively) realize a zero-time reconfiguration for the FPGA. In one implementation, dynamic macros and supermacros are loaded and unloaded according to timing constraints that are described in a time-space macro cell usability file that defines the conditions or constraints which use clock cycles or signal controls.

FIG. 3 illustrates an architecture of an FPGA 300 including a partitioning between a static part 302 and a dynamic part comprising (3) reconfigurable dynamic macros 304-308. Though (3) dynamic macros are illustrated in FIG. 3, FPGA can include a different number of dynamic macros. Each of dynamic macros 304-308 can be configured at different times. For example, while dynamic macro 304 is performing a computation, dynamic macro 306 and/or dynamic macro 308 can be re-programmed to implement a new logic function. In one implementation, the different parts and contexts of FPGA 300 are placed and routed one by one. With respect to the layout shown in FIG. 3, static part 302 can be placed as part of a design context and locked until layout of FPGA 300 is completed. In one implementation, a software tool is given an EDIF file for the top-level design of an FPGA holding the static part and dynamic macros as black boxes and separate EDIF files, one for each dynamic macro. The software tool also reads the time-space macro cell usability file and then organizes the different design contexts of the FPGA. Dynamic macros 304-308 can be placed at an optimum position relative to static part 302. In one implementation, static part 302 and dynamic macros 304-308 are respectively placed using one or more static wrappers and dynamic wrappers as discussed in greater detail below in connection with FIG. 7.

Each dynamic macro 304-308 (as well as each supermacro (not shown)) is assigned a specific area on FPGA 300 upon first placement for use in every future load. Static routing is locked and preserved throughout the processing of the different design contexts while dynamic routing is created on the fly whenever needed. In one implementation, when dynamic routing is removed, routing information is stored in a database for future use so that the dynamic routing can be re-created in the exact same way when the associated dynamic macro is re-loaded. Accordingly, timing properties associated with dynamic macros (e.g., dynamic macros 304-308) can be retained.

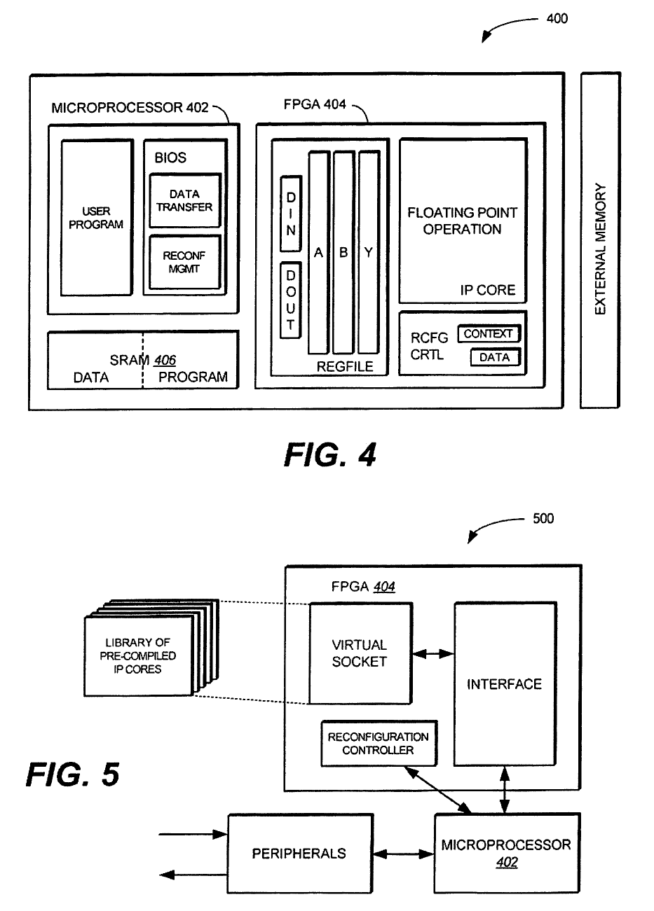

FIG. 4 illustrates an example implementation of a system-on-chip (SoC) platform 400 including a microprocessor 402, an FPGA 404, and a memory (SRAM) 406. In one implementation, microprocessor 402 is in accordance with a Von Neumann architecture and executes user program by retrieving instructions and data from SRAM 406. Microprocessor 402 can be in accordance with a Harvard architecture in which SoC platform 400 would include a separate memory for respectively storing data and programs (or instructions). Microprocessor 402 can execute user programs specified in, for example, C or another programming language. In one implementation, microprocessor 402 is connected to FPGA 404 through a dedicated data bus and a number of select lines and interrupt request lines (not shown). In addition, microprocessor 402 has access to configuration logic that configures FPGA 404.

A combination of a microprocessor and an FPGA supporting dynamic reconfiguration on a SoC platform (such as SoC platform 400) can be used to implement a general-purpose microprocessor system with a hardware accelerator. Dynamic reconfiguration increases the power of such a platform by increasing the number of user functions or computations that can be supported by the hardware accelerator.

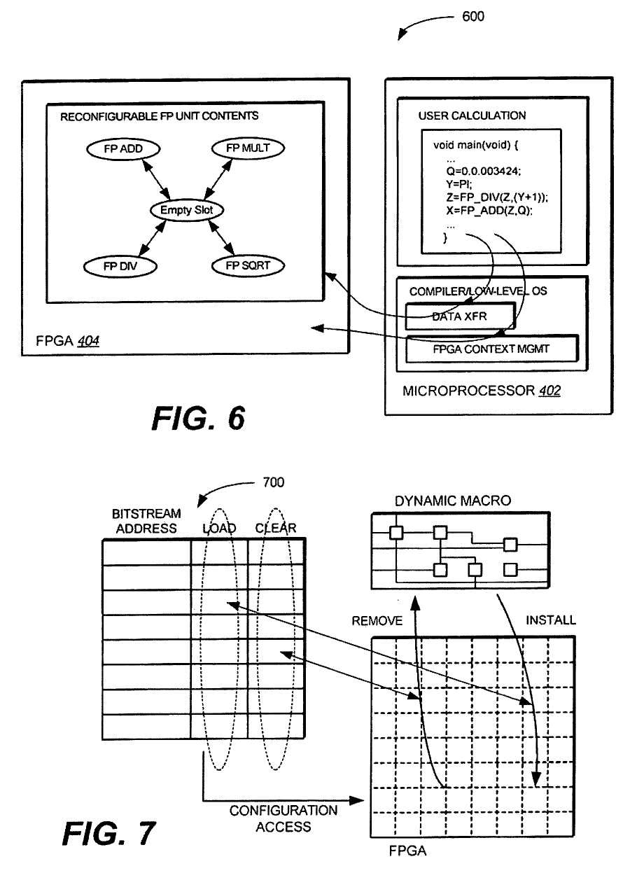

In one implementation, to ease the use of such a reconfigurable hardware accelerator by an application programmer writing software for the microprocessor, a transparent infrastructure for FPGA reconfiguration is introduced that hides both the hardware accelerator and the reconfiguration of the hardware accelerator behind usual function calls. When not considering different execution times due to reconfiguration, the reconfiguration process is transparent to the application software. In one implementation, access to the FPGA coprocessor (IP core) is implemented as a special low-level function. Parameters of the low-level function (including the required operation and any associated operands) can be passed either as direct values in the case of a register transfer, or as a starting address of their location and number in the case of a transfer from SRAM 406. Referring to FIG. 6, when the low-level OS (operating system) of microprocessor 402 detects a request for an operation different than the current function implemented within FPGA 404, the low-level OS calls a function that reconfigures FPGA 404. The function first translates the requested operation to the context (address) of the corresponding bitstream and writes the address to the context register of the reconfiguration controller and initiates operation of the function.

Referring back to FIG. 4, the reconfigurable hardware accelerator implements different operations that are executed by FPGA 404. The hardware accelerator can be accessed by an application program executed by microprocessor 402. In the example implementation shown in FIG. 4, FPGA 404 is operable to implement basic floating-point operations—e.g., ADD, MUL, DIV, SQRT—in a 24-bit precision (1-bit sign, 6-bit exponent, 17-bit mantissa). In one implementation, all of the floating-point operations cannot be performed at the same time due to size constraints of FPGA 404. Accordingly, in this implementation, FPGA 404 is reconfigured “on the fly” as a given calculation becomes necessary.

In operation, microprocessor 402 receives a data block from a serial port, and then uses the FPGA floating-point coprocessor to calculate the results for received values. The main parts of SoC platform 400 are the floating-point coprocessor (designated as IP core), the data management—i.e., the data transfer part of the microprocessor low-level OS and the REGFILE block in FPGA 404, and the reconfiguration controller. The reconfiguration controller is illustrated as RECONG MGMT within microprocessor 402, and is shown as RCFG CTRL within FPGA 404. Accordingly, the reconfiguration controller can be implemented with a microprocessor, or be implemented in the static part of an FPGA.

In one implementation, the external memory stores the information and context (or bitstreams) needed to reconfigure the hardware accelerator. An FPGA register (CONTEXT in RCFG CTRL) can be used for context (bitstream) selection and as a data path between the external memory, the reconfiguration controller, and the FPGA configuration logic (e.g., dynamic macros). The static part of the FPGA can implement an address register that consists of the context register (MS bits) and a counter. When the context register is written to, the counter is reset. Each time data is read from the external memory by the reconfiguration controller the counter increments. When the top address specified in the bitstream header is reached—i.e., when the reconfiguration of the dynamic part of the FPGA is completed—the FPGA interrupts the microprocessor. In one implementation, the reconfiguration controller fetches FPGA configuration information from the bitstream memory and writes the configuration information to FPGA configuration memory.

FIG. 5 illustrates a higher level view 500 of microcontroller 402 and FPGA 404 shown in FIG. 4. According to the implementation shown in FIG. 5, microprocessor 402 is operable to be reconfigured based on dynamic macros within FPGA 404. In one implementation, a library of pre-compiled IP cores are associated with a virtual socket of FPGA 404. The library of pre-compiled IP cores can be stored in the external memory shown in FIG. 4. The reconfiguration controller manages the reconfiguration of FPGA 404. Based on inputs to a software tool, the reconfiguration controller signals when to reconfigure the virtual socket and which IP core to load. At the time the design is completed, a designer checks that all the required library elements exist, places and routes the design, and generates appropriate bitstreams for the entire hardware design, including the virtual socket for the reconfigurable elements. The reconfigurable elements (peripherals, interfaces, etc.) are individually placed and routed to fit the virtual socket. The designer then assembles all bitstreams into a “master” bitstream file, with memory pointers, that is stored in external memory (as discussed in greater detail below).

FIG. 6 shows an example application view 600 of microprocessor 402 and FPGA 404 according to one implementation. As shown in FIG. 6, FPGA 404 is reconfigured (or re-programmed) to perform a different calculation (e.g., FP ADD, FP MULT, FP DIV, FP SQRT) based on the requirements of a user calculation (or code) implemented in the C programming language. The code first prepares data for calculation, and then calls FPGA 404 to process the data. The nature of the computation (whether carried out by microprocessor 402 or in the fabric of FPGA 404) and the reconfiguration of FPGA 404 is totally transparent to the application controller (reconfiguration time not considered). That is, the infrastructure of FPGA 404 is transparent to the application programmer. In one implementation, the only place at which the microprocessor-FPGA interaction can be noticed is the function call FP_ADD, FP_SQRT, etc. Each operand in the example is encoded using 24 bits, and the amount of words passed to the hardware accelerator is determined by the architecture of the microprocessor-FPGA data bus (not shown). Based on the name of the function called (e.g., FP_ADD, FP_SQRT, etc.), in one implementation, the BIOS determines if reconfiguration of FPGA 404 is necessary. The BIOS then transfers the data to the coprocessor and gets the results of the processing.

Referring back to FIGS. 4 and 5, the reconfiguration controller is responsible for the correct transfer of data between a storage (e.g., the external memory) that contains the configuration information (e.g., the bitstreams) and the programmable fabric (e.g., dynamic macros and/or supermacros) within FPGA 404. In one implementation, FPGA 404 is a lookup table-based FPGA with a random access to the external memory (or configuration memory), offering a contention free configuration (and reconfiguration) of the FPGA during operation. Based on SoC platform 400, the reconfiguration controller can be implemented within a central processing unit (CPU) or in the FPGA. When implemented within a CPU, the reconfiguration controller can be specified in a sequential computer program (e.g., C), and when implemented within the FPGA, the reconfiguration controller can be specified in VHDL. Both of these implementations, however, share common structure: an external scheduler triggers the data transfer and on completion of the transfer the reconfiguration controller signals to the scheduler (and other data management blocks) that data transfer has completed.

In one implementation, the reconfiguration controller contains two parts. The first part (e.g., the bitstream starting address generation) locates the required partial bitstream in the master bitstream file stored in the external memory. The second part is responsible for proper timing and completeness of the transfer of the partial bitstream. The structure of the first part, in one implementation, depends on the selected organization of the master bitstream file (discussed in greater detail below). The second part (in one implementation) consists of a memory address register for accessing the external memory and either an end-of-partial-bitstream-mark detection circuit, or a top address register that is loaded with the top address of valid data for each partial bitstream to be transferred. As discussed above, a partial bitstream is a bitstream that reconfigures specific logic components within an FPGA and not the entire FPGA (as would be the case with full bitstreams).

The organization of the bitstream is generally given by the architecture of the external memory and by the properties of the reconfiguration controller. In one implementation, since each FPGA configuration can be translated to two bitstreams—one that installs a given functionality and another that removes the functionality—the two bitstreams can be kept as a single bitstream having the following organization: <FPGA address><install data><remove data>. Such an organization of a bitstream address is shown in FIG. 7. With respect to FIG. 7, the bitstream address column of table 700 corresponds to the FPGA address, the load column corresponds to the install data, and the clear column corresponds to the remove data. The organization of the bitstream address reduces significantly the amount of data stored in the external memory because the organization only stores address information once, whereas conventional systems typically store the same address information twice within two individual bitstreams (e.g., an install bitstream and a remove bitstream). Accordingly, the configuration data for installing and removing dynamic macros can be organized in a single bitstream so as to avoid repeating address information.

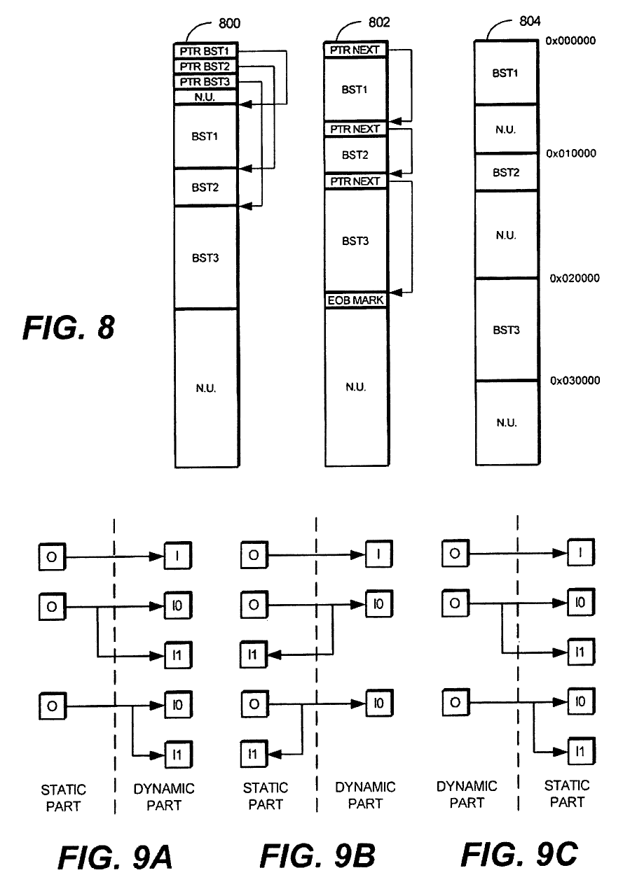

FIG. 8 shows three possible organization schemes of a master bitstream file that holds configuration information for all required FPGA functions or computations implemented through dynamic reconfiguration, in which each configuration (or dynamic macro) is installed and removed by an individual bitstream. Specifically, FIG. 8 shows three master bitstream files 800-804 discussed below.

Master bitstream file 800 includes an index table of pointers (e.g., pointers PTR BST1, PTR BST2, PTR BST3) at the beginning of the bitstream to redirect the reconfiguration controller to the specific bitstreams (e.g., bitstreams BST1, BST2, BST3) as needed. An advantage of the organization scheme of master bitstream file 800 is that each bitstream within master bitstream file 800 can be accessed in a constant time, since two addressing operations are needed—the first addressing operation retrieves the bitstream starting address from the index table and the second addressing operation stores the bitstream starting address to a bitstream address register.

Master bitstream file 802 is based on a linked list structure. In particular, master bitstream file 802 reserves a word at the beginning of each bitstream that contains a length of the following bitstream. An advantage of the organization scheme of master bitstream file 802 is that master bitstream file 802 can contain an unlimited number of addressable bitstreams. In addition, new bitstreams can easily be added to the end of master bitstream file 802. The time required to retrieve a bitstream from master bitstream file 802, however, is not constant. For example, to generate the starting address of the n^{th} bitstream, (n) read/add operations are required. In one implementation, the time to generate the starting address of a bitstream is limited according to the maximal number of bitstream times the time required to read and add one bitstream length word contained in the master bitstream file.

Master bitstream 804 implements features of both of the master bitstream files discussed above, and with a simple hardware implementation. More specifically, master bitstream file 804 reserves fixed slots for all bitstreams, and in addition master bitstream file 804 includes the length of the following bitstream at the beginning of each bitstream. Accordingly, the time required to generate the starting address of a bitstream is very fast and access time of a bitstream is constant. Padding bitstreams to a constant size, however, can affect memory space of, for example, an external memory that stores master bitstream files.

In one implementation, partial bitstreams for dynamic macros are created by comparing two bitstream files—one held by a design context having a specific dynamic macro present, and the other held by the same design context without the dynamic macro present. The differences between the two bitstream files hold only the elementary changes on the FPGA regarding the existence or the removal of a specific dynamic macro are, therefore, optimized in size.

Reconfiguration in FPGAs is implemented as a data transfer operation between bitstream storage (e.g., the external memory of FIG. 4) and special locations inside of the FPGA (e.g., FPGA 404). Given the usual sizes of configuration bitstreams, the necessary storage size can exceed the size of available memory built into an FPGA and, therefore, an external memory must be used to store the bitstreams. In one implementation, the external memory can have a conventional address/data parallel interface, or can use an SPI compatible interface. The read/write controller can be reduced to a simpler read-only version for the reconfiguration process. That is, the complete functions of the read/write controller can be used in a prepatory stage to download the master bitstream file to the external memory; however, if it is expected that the configuration data will not be modified (by an end user), then the read/write controller can be simplified to only perform read operations to spare chip resources and increase design robustness.

Compared to conventional VHDL design, the use of dynamic reconfiguration requires additional constraints on the synthesis of user (dynamic) macros. The designs are usually synthesized as several independent user designs that are packed together during placement and routing—i.e., when all valid FPGA configurations must be assembled to produce valid configuration bitstreams. In general, there are two main synthesis issues: net connectivity, and preservation of macro ports.

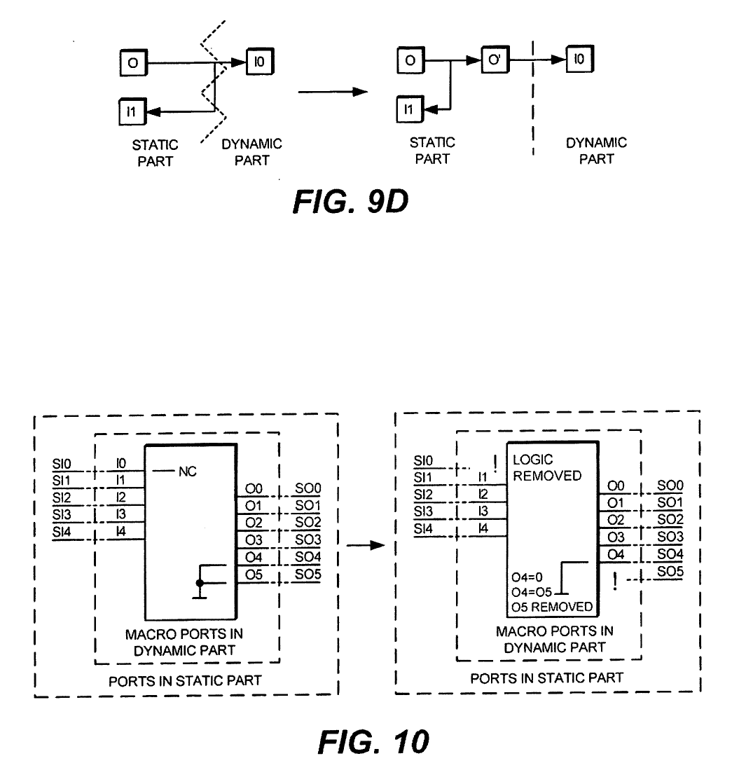

Synthesis issues associated with net connectivity will now be discussed in connection with FIGS. 9A-9C. In particular, FIG. 9A illustrates output from the static part feeding inputs to the dynamic part. FIG. 9B illustrates output from the static part feeding inputs to the dynamic part as well as back to the static part. FIG. 9C illustrates output of the dynamic part feeding inputs to the static part (the opposite of FIG. 9A).

A problem that can arise with respect to the net connectivity shown in FIG. 9A is where the actual net branching occurs, and the problem is solved using placement and routing techniques as described in greater detail below. A problem that can arise with respect to the net connectivity shown in FIG. 9C is that during reconfiguration (of the dynamic part) or in contexts where the outputs of the dynamic part are not present, then the inputs to the static part of the FPGA will be floating—i.e., the inputs to the static part will have undefined values. Such a problem can be solved on the synthesis level, for example, by using an interface buffer in the static part that is enabled only when the corresponding dynamic part (logic) is present. A problem that can arise with respect to the net connectivity shown in FIG. 9B is that an application programmer may assume that an input to the static part that is connected to an output of the static part should always remain connected no matter which dynamic macros are loaded into the dynamic part of the FPGA. This is not usually the case, since during reconfiguration of the dynamic part, a router typically removes all nets that have at least one port in the affected dynamic part.

FIG. 10 illustrates an example where, due to a synthesis, the number of (dynamic) macro ports (or input port to the dynamic part) is reduced and net connectivity between ports in the static part and the macro ports is changed. In the example of FIG. 10, the user macro connects signal SI0 to a logic that is removed (or optimized away) during synthesis, and the logic driving output signals O4, O5 are also optimized away and replaced with a constant low. Since the top-level design must be synthesized as a separate design, the top-level design uses the dynamic logic instantiated as black-box components, which preserves all interface inputs and outputs. On the other hand, when synthesizing the user macro, the interface ports of the user macro are generated to reflect the actual inputs and outputs used by the logic. When integrating a user macro with a top-level design, during mapping, placement, and routing, the software design tool will find an inconsistency in the net connectivity between the static part and the dynamic part and, therefore, generate an error. In conventional modular designs, such an error is typically not generated since the design flow is the other way around—i.e., the application programmer first defines all user macros, gets the post-synthesis interface definitions of the user macros, and then instantiates the user macros as black-box components in the top-level design. There is also no need to unify interfaces of different user macros, as is the case with reconfigurable supermacros.

Consequently, a systematic solution to the problems associated with net connectivity (or net routing) between the dynamic part and the static part as well as the preservation of user macro ports requires a new approach to logic synthesis and routing. One workaround to the problems discussed above includes, in one implementation, preserving all defined entity ports used in user macros, and transforming all connections with mixed inputs and outputs in the static part and the dynamic part to connections with no direct “static input to static output” connections as shown in FIG. 9D. Such a workaround can be implemented by using interface buffers generated in a core generator. The interface buffers can be instantiated as black-boxes in the top-level design as well as in each dynamic macro.

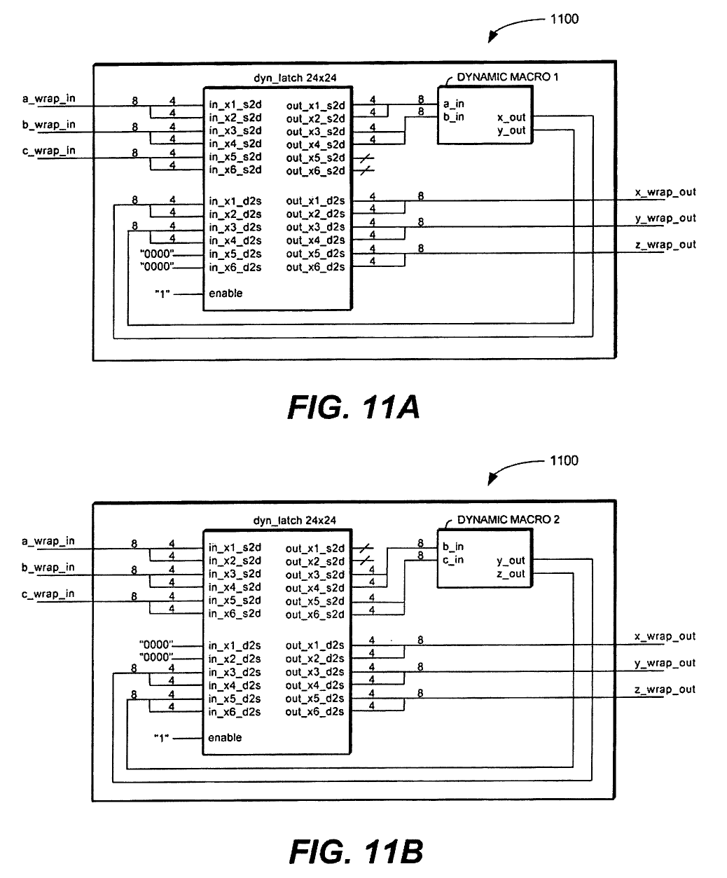

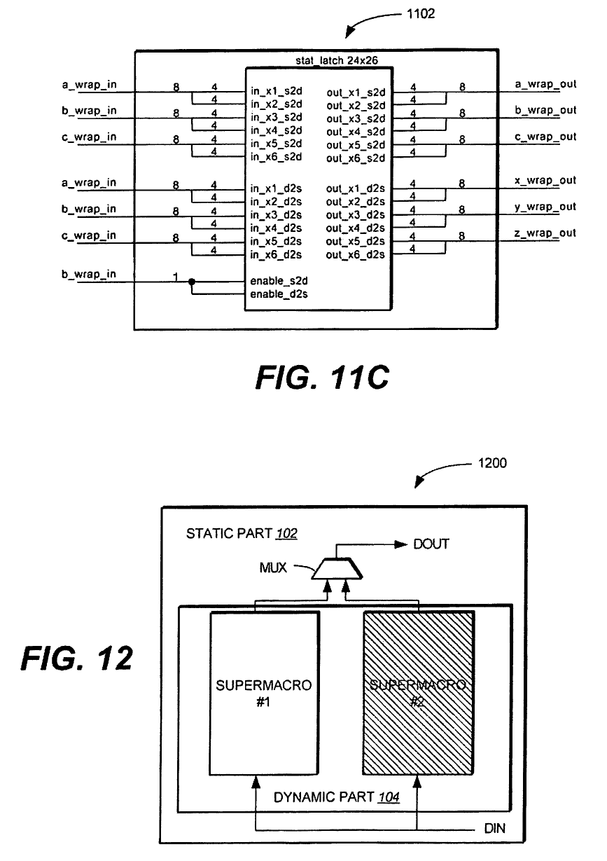

A suitable solution for current design flows (in one implementation) is to introduce interface wrappers. An interface wrapper is a component that consists of several static-to-dynamic and dynamic-to-static connectors implemented either as buffers, latches, or registers. In one implementation, one static wrapper is always associated with one dynamic wrapper, and both wrappers are created as regular macros and are placed so that the dynamic wrapper determines the area of the dynamic macro (e.g., the perimeter of the dynamic macro), and the static wrapper is just large enough to include the dynamic wrapper with the dynamic macro. FIGS. 11A-11B respectively illustrate two dynamic macros (e.g., dynamic macro 1 and dynamic macro 2) wrapped using the same dynamic wrapper 1100, and FIG. 11C illustrates the corresponding static wrapper 1102 instantiated in the static part.

An advantage of using pre-placed pairs (or couples) of wrappers (one dynamic wrapper together with one static wrapper) is that dynamic macros or supermacros can be more easily placed and integrated with the static part of the design of an FPGA since the wrappers themselves define the locations of the interface elements and the maximum available macro area. The definition of the interface elements guides the placement and routing algorithms that work independently on the static and dynamic parts and, therefore, helps to obtain better results compared to the situation without explicitly defined locations of the interface elements. The pre-placed and pre-routed static and dynamic wrappers are organized in a separate design library. The interface elements can be any of buffers (e.g., lookup tables implementing a function Y=A), registers (e.g., edge sensitive D-type flip flops), or latches (e.g., level-sensitive D-type flip flops).

FIG. 12 illustrates one implementation of a simulated context reconfiguration on an FPGA 1200 without the context reconfiguration capability. Referring to FIG. 12, supermacro #1 is computing, while supermacro #2 is being reconfigured. Both supermacros have equivalent functionality, e.g., for each supermacro there are bitstreams that configure it to an equivalent function. On the application level both supermacros are seen as one supermacro with zero-time reconfiguration (when the application computes longer than is required for reconfiguration).

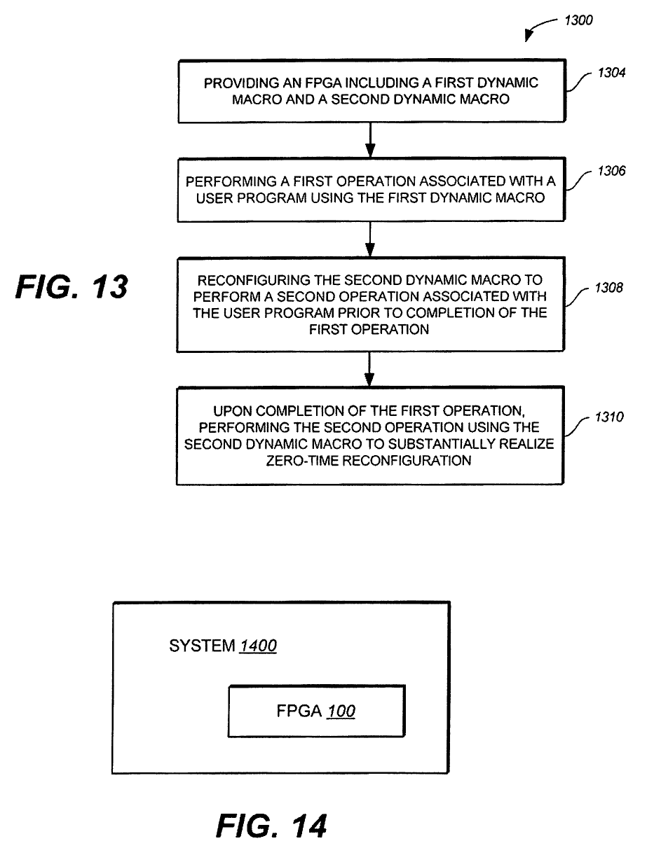

FIG. 13 illustrates a method 1300 of operation of an FPGA according to one implementation. A first dynamic macro (e.g., dynamic macro 304) and a second dynamic macro (e.g., dynamic macro 306) are provided in an FPGA (e.g., FPGA 300) (step 1302). More generally, two or more dynamic macros can be provided in the FPGA. A first operation associated with a user program is performed (or executed) using the first dynamic macro (step 1304). Operations associated with the user program can be any operation associated with a computer program, for example, floating-point operations or other types of numeric operations. The second dynamic macro is reconfigured to perform a second operation associated with the user program prior to completion of the first operation (step 1308). Upon completion of the first operation, the second operation is performed using the second operation to substantially realize a zero-time reconfiguration for the FPGA (step 1310).

FIG. 14 illustrates a system 1400 including an FPGA in accordance with the present invention (e.g., FPGA 100 of FIG. 1). System 1400 can be any type of system or ASIC. For example, system 1400 can be a data storage, wireless and communication system, data encryption system, or a computer system.

Various implementations of an FPGA and methods for operating an FPGA have been described. Nevertheless, one or ordinary skill in the art will readily recognize that various modifications may be made to the implementations, and any variation would be within the spirit and scope of the present invention. For example, static-to-dynamic and dynamic-to-static nets can be handled differently than as discussed above, and there can be different access methods to the FPGA configuration memory. In general, dynamic macros can be described in other ways than just VHDL, e.g. Verilog, Handel-C, System C, or schematic diagrams. Also, bitstreams discussed above can have a different configuration—e.g., not just <address><data>. In general, an FPGA in accordance with the invention can have a different number of dynamic macros and/or supermacros. Additionally, configuration schedules and application scenarios (other than a reconfiguration triggered by an application) can invoke reconfiguration of an FPGA in accordance with the invention. Accordingly, many modifications may be made by one of ordinary skill in the art without departing from the spirit and scope of the following claims.

What is claimed is:

1. A method of performing one or more operations associated with a user program using a field programmable gate array (FPGA) and dynamic reconfiguration, the method comprising:
providing a first dynamic macro and a second dynamic macro in the field programmable gate array (FPGA), the first dynamic macro and the second dynamic macro each representing logic within the field programmable gate array (FPGA) that can be reconfigured;
executing a first operation associated with the user program using the first dynamic macro;
reconfiguring the second macro to execute a second operation associated with the user program prior to completion of the first operation; and
upon completion of the first operation, executing the second operation using the second dynamic macro.

2. The method of claim 1, wherein the field programmable gate array (FPGA) substantially realizes zero-time reconfiguration between executing the first and second operations.

3. The method of claim 1, wherein the first operation or the second operation comprises a numeric operation.

4. The method of claim 1, wherein providing a first dynamic macro and a second dynamic macro further comprises providing a supermacro, the supermacro containing one or more third dynamic macros for performing operations associated with the user program.

5. The method of claim 1, further comprising organizing configuration data to reconfigure the second dynamic macro into a master bitstream file.

6. The method of claim 5, wherein the master bitstream file stores one or more partial bitstreams according to the following organization: <FPGA address><install data><remove data>, wherein each partial bitstream represents the configuration data.

7. The method of claim 6, wherein the master bitstream file has an addressing mechanism that includes an index table at a beginning of the master bitstream file that points to the beginning and end of each partial bitstream contained within the master bitstream file.

8. The method of claim 6, wherein the master bitstream file has an addressing mechanism that includes pointers at a beginning of each partial bitstream that point to a beginning of a next partial bitstream.

9. The method of claim 6, wherein the master bitstream file has an addressing mechanism that comprises using data blocks of fixed length so as to contain a largest partial bitstream, and wherein a first word of each data block contains a length of an associated partial bitstream.

10. A field programmable gate array (FPGA) comprising:
a static part that corresponds to logic within the field programmable gate array (FPGA) that is present in substantially all configurations of the field programmable gate array (FPGA); and
a dynamic part including a first dynamic macro and a second dynamic macro, the first dynamic macro and the second dynamic macro each representing logic within the field programmable gate array (FPGA) that can be reconfigured, wherein
the first dynamic macro is operable to execute a first operation associated with a user program;
the second macro is operable to be reconfigured while the first dynamic macro is executing the first operation; and
upon completion of the first operation, the second operation is operable to execute a second operation associated with the user program using the second dynamic macro.

11. The field programmable gate array (FPGA) of claim 10, wherein the field programmable gate array (FPGA) substantially realizes zero-time reconfiguration between executing the first and second operations.

12. The field programmable gate array (FPGA) of claim 10, wherein the first operation or the second operation comprises a numeric operation.

13. The field programmable gate array (FPGA) of claim 10, wherein the dynamic part further includes a supermacro containing one or more third dynamic macros for performing operations associated with the user program.

14. The field programmable gate array (FPGA) of claim 10, wherein configuration data used to reconfigure the second dynamic macro is organized into a master bitstream file.

15. The field programmable gate array (FPGA) of claim 14, wherein the master bitstream file stores one or more partial bitstreams according to the following organization: <FPGA address><install data><remove data>, wherein each partial bitstream represents the configuration data.

16. The field programmable gate array (FPGA) of claim 15, wherein the master bitstream file has an addressing mechanism that includes an index table at a beginning of the master bitstream file that points to the beginning and end of each partial bitstream contained within the master bitstream file.

17. The field programmable gate array (FPGA) of claim 15, wherein the master bitstream file has an addressing mechanism that includes pointers at a beginning of each partial bitstream that point to a beginning of a next partial bitstream.

18. The field programmable gate array (FPGA) of claim 15, wherein the master bitstream file has an addressing mechanism that comprises using data blocks of fixed length so as to contain a largest partial bitstream, and wherein a first word of each data block contains a length of an associated partial bitstream.

19. A system for performing a specific task, the system comprising:
a field programmable gate array (FPGA) operable to execute instructions associated with the task, the field programmable gate array (FPGA) including,
a static part that corresponds to logic within the field programmable gate array (FPGA) that is present in substantially all configurations of the FPGA; and
a dynamic part including a first dynamic macro and a second dynamic macro, the first dynamic macro and the second dynamic macro each representing logic within the FPGA that can be reconfigured, wherein
the first dynamic macro is operable to execute a first operation associated with the task;
the second macro is operable to be reconfigured while the first dynamic macro is executing the first operation; and
upon completion of the first operation, the second operation is operable to execute a second operation associated with the task using the second dynamic macro.

20. The system of claim 19, wherein the system is associated with one of a data storage, wireless and communication system, data encryption system, or a computer system.
